(19) United States
(12) Patent Application Publication
(10) Pub. No.: US 2026/0066791 A1
(43) Pub. Date: Mar. 5, 2026

(54) SWITCHING POWER SUPPLY

(71) Applicant: Silergy Semiconductor Technology (Hangzhou) LTD, Hangzhou (CN)

(72) Inventors: Qian Zeng, Hangzhou (CN); Huiqiang Chen, Hangzhou (CN)

(21) Appl. No.: 19/307,164

(22) Filed: Aug. 22, 2025

(30) Foreign Application Priority Data
Aug. 30, 2024 (CN) 202411217223.3

(51) Int. Cl. H02M 3/158; H02H 1/00; H02H 7/12; H02M 1/36

(52) U.S. Cl. CPC H02M 3/158; H02H 1/0007; H02H 7/1213; H02M 1/36

(57) ABSTRACT

A switching power supply can include: a boost converter configured to perform voltage conversion on an input voltage of an input terminal of the switching power supply to generate an output voltage of an output terminal of the switching power supply in a normal operating phase; a bus protection switch coupled between the input terminal of the switching power supply and the boost converter, and configured to be turned off in response to a short-circuit fault of the switching power supply; a first diode coupled between a common node between the bus protection switch and the boost converter and a ground terminal; and where a duty cycle of the bus protection switch is controlled to make the output voltage rises slowly in at least part of a startup phase, such that a short-circuit detection is performed.

### RELATED APPLICATIONS

This application claims the benefit of Chinese Patent Application No. 202411217223.3, filed on Aug. 30, 2024, which is incorporated herein by reference in its entirety.

### FIELD OF THE INVENTION

The present invention generally relates to the field of power electronics, and more particularly to switching power supplies and associated short-circuit detection methods.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. Switching power supplies have a wide variety of applications in modern electronics. For example, switching power supplies can be used to drive light-emitting diode (LED) loads.

### BRIEF DESCRIPTION OF THE DRAWINGS

FIG. 1 is a schematic block diagram of an example switching power supply.

FIG. 2 is a schematic block diagram of a first example switching power supply, in accordance with embodiments of the present invention.

FIG. 3 is a waveform diagram of example operation of the switching power supply, in accordance with embodiments of the present invention.

FIG. 4 is a schematic block diagram of an example portion of a driving voltage generation circuit of a bus protection switch within the example switching power supply, in accordance with embodiments of the present invention.

FIG. 5 is a waveform diagram of example operation of the driving voltage generation circuit of the bus protection switch within the switching power supply, in accordance with embodiments of the present invention.

FIG. 6 is a schematic block diagram of a second example switching power supply, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

A boost converter is a non-isolated step-up circuit known for its simple architecture and low cost, and is widely used in applications that do not require electrical isolation. However, when the boost converter powers up, a sudden change in voltage can result in a large surge current, which may damage electronic components. Thus, preventing such surge currents during power-up, and particularly in boost converters, is becoming increasingly important. Additionally, during the power-on phase, if the output terminal or the non-grounded terminal of the main power switch is shorted to ground, a large current may flow through the input bus, potentially causing further damage of electronic devices.

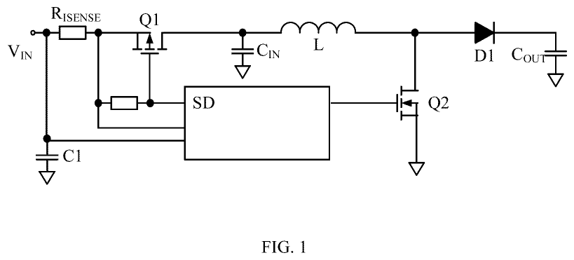

Referring now to FIG. 1, shown is a schematic block diagram of an example switching power supply. In this example, a boost-based switching power supply can include bus sensing resistor R_{ISENSE}, bus switch Q1, a boost converter, and output capacitor Cour. In this arrangement, short-circuit detection can be performed by monitoring the voltage across the bus sensing resistor R_{ISENSE}, which may require the control circuit to include two dedicated high-side sampling pins to sample the voltages of two ends of bus sensing resistor R_{ISENSE}, respectively, in order to capture the voltage across bus sensing resistor R_{ISENSE}. When the output terminal of the switching power supply is shorted to ground, or when the common node of switch Q2 and diode D1 in the boost converter is shorted to ground, a large current may flow through the input bus. This can result in a voltage across bus sensing resistor R_{ISENSE} that exceeds a predefined threshold, thereby triggering the short-circuit protection and turning off bus switch Q1. However, this approach may not only require additional detection pins, but also can result in power loss across bus sensing resistor R_{ISENSE}, reducing overall system efficiency.

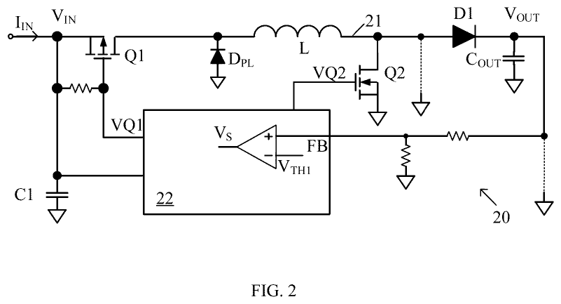

Referring now to FIG. 2, shown is a schematic block diagram of a first example switching power supply, in accordance with embodiments of the present invention. In this particular example, switching power supply 20 can include boost converter 21, bus protection switch Q1, and control circuit 22.

Boost converter 21 can perform voltage conversion on a direct current (DC) input voltage V_{IN} of an input terminal of the switching power supply, in order to generate output voltage V_{OUT} of an output terminal of the switching power supply in a normal operating phase. In this particular example, boost converter 21 can include inductor L, main power transistor Q2, diode D1, and output capacitor Cour. Inductor L can be coupled to the input terminal of the switching power supply, and main power transistor Q2 can connect to inductor L. Diode D1 can connect to both inductor L and main power transistor Q2. Output capacitor C_{OUT} can connect to the output terminal of the switching power supply, and the voltage across output capacitor Cour can be output voltage V_{OUT}.

Bus protection switch Q1 can connect between the input terminal of switching power supply 20 and boost converter 21. For example, a first power terminal of bus protection switch Q1 can connect to the input terminal of switching power supply 20, and a second power terminal of bus protection switch Q1 can connect to a first terminal of inductor L in boost converter 21. Bus protection switch Q1 can be turned off when a short-circuit fault occurs in switching power supply 20. That is, bus protection switch Q1 can be turned off when short-circuit detection signal V_{S} output by control circuit 22 is activated. For example, when the output terminal of switching power supply 20 is shorted to ground, or a non-grounded terminal of main power transistor Q2 is shorted to ground, short-circuit detection signal V_{S} can be active, in order to prevent relatively large current from being generated on an input bus, thereby protecting the electronic device from damage.

Switching power supply 20 can also include diode D_{PL}, where a cathode of diode D_{PL} can connect to a common node between bus protection switch Q1 and boost converter 21, and an anode of diode D_{PL} can connect to a ground terminal. Further, bus protection switch Q1, diode D_{PL}, and inductor L in boost converter 21 can form a buck converter. Control circuit 22 can control the buck converter to operate in a first time interval of a startup phase of the switching power supply, in order to make a current of inductor L within a preset current range, such that output voltage V_{OUT} rises slowly and a short-circuit detection is performed. In a second time interval of a startup phase, control circuit 22 may adjust output voltage V_{OUT} to initiate a soft start of the switching power supply 20, making output voltage V_{OUT} to rise and approach input voltage V_{IN}, where the second time interval is after the first time interval.

For example, bus protection switch Q1 is a P-type field-effect transistor, where a source (e.g., the first power terminal) of bus protection switch Q1 can connect to the input terminal of switching power supply 20, a drain (e.g., the second power terminal) of bus protection switch Q1 can connect to the first terminal of inductor L in boost converter 21, and a control terminal of bus protection switch Q1 may receive control signal VQ1 output by control circuit 22. When a value of control signal VQ1 is lower than input voltage V_{IN} (e.g., a difference between control signal VQ1 and input signal V_{IN}) exceeds a turn-on threshold of bus protection switch Q1, bus protection switch Q1 may be completely turned on.

In particular embodiments, control circuit 22 can perform short-circuit detection on switching power supply 20 in the first time interval of the startup phase, and can control the operating states of bus protection switch Q1 so that the current of inductor L is maintained within the preset current range in the short-circuit detection phase. In the first time interval, the short-circuit detection signal V_{S} may be generated by comparing feedback signal FB of the output voltage V_{OUT} against thresholdV_{TH1}. In one example, in the first time interval, short-circuit detection signal V_{S} may be generated by determining whether feedback signal FB of output voltage V_{OUT} is lower than threshold V_{TH1}.

Further, when the short-circuit detection is performed, control circuit 22 can control the operating states of bus protection switch Q1, such that the current of inductor L is maintained within the preset current range. The preset current range can be relatively small and less than the inductor current when boost converter 21 operates in a normal operating phase. When the short-circuit detection is performed, the current of inductor L can charge output capacitor C_{OUT}, and when both the output terminal of switching power supply 20 and the non-grounded terminal of main power transistor Q2 are not grounded, output voltage V_{OUT} across output capacitor C_{OUT} may gradually rise and can reach threshold V_{TH1}. Also, when either the output terminal of switching power supply 20 or the non-grounded terminal of main power transistor Q2 is short-circuited to the ground, output voltage V_{OUT} on output capacitor C_{OUT} may remain near zero and not reach threshold V_{TH1}. Based on this, when feedback signal FB of output voltage V_{OUT} is detected to be lower than threshold V_{TH1}, control circuit 22 may determine that the switching power supply has a short-circuit fault and activate short-circuit detection signal V_{S}. Also, when feedback signal FB of output voltage V_{OUT} rises to threshold V_{TH1}, control circuit 22 may determine that no short-circuit fault is present in switching power supply 20 and deactivate short-circuit detection signal V_{S}.

As shown in FIG. 2, feedback signal FB can be input to a non-inverting input terminal of a comparator, and threshold V_{TH1} input to an inverting input terminal of the comparator. When feedback signal FB is lower than threshold V_{TH1}, short-circuit detection signal V_{S} output by an output terminal of the comparator can be low. That is, the active short-circuit detection signal V_{S} can be at a low level, and the inactive short-circuit detection signal V_{S} can be at a high level. In other examples, the active short-circuit detection signal V_{S} may be a high level, and the inactive short-circuit detection signal V_{S} can be at a low level.

Further, control signal VQ1 of bus protection switch Q1 can be determined based on short-circuit detection signal V_{S} and a pulse-width modulation (PWM) signal SD. For example, when short-circuit detection signal V_{S} is active, that is, when the switching power supply has a short-circuit fault, control signal VQ1 can enable bus protection switch Q1 to be turned off. When short-circuit detection signal V_{S} is inactive, that is, when no short-circuit fault is present in the switching power supply, control signal VQ1 can be consistent with (e.g., the same as) PWM signal SD of bus protection switch Q1 in the startup phase. For example, the duty cycle of PWM signal SD of bus protection switch Q1 in the startup phase can be a predetermined duty cycle D.

Based on this short-circuit detection principle, the switching power supply of particular embodiments can eliminate the need to dispose a sampling circuit (e.g., bus detection resistor R_{ISENSE} in FIG. 1) between the input terminal of switching power supply 20 and boost converter 21 for short-circuit protection. When the small inductor current is charged to output capacitor C_{OUT}, and either the output terminal of switching power supply 20 or the switching node (e.g., the non-grounded terminal) of main power transistor Q2 is short-circuited to ground, output voltage V_{OUT} may not rise to the predetermined value (e.g., threshold V_{TH1}), thereby triggering the short-circuit protection, and turning off bus protection switch Q1.

When feedback signal FB of output voltage V_{OUT} is detected to be lower than threshold V_{TH1} during the first time interval of the startup phase or in the normal operating phase (e.g., when switching power supply 20 has a short-circuit fault), control circuit 22 can turn off bus protection switch Q1 or be controlled to stop operating, and then reenter the startup phase after a predetermined delay.

When it is detected that feedback signal FB of output voltage V_{OUT} rises to threshold V_{TH1} during the first time interval (e.g., when no short-circuit fault is present in switching power supply 20), control circuit 22 can initiate the soft start of switching power supply 20 in the second time interval of the startup phase, such that output voltage V_{OUT} is close to input voltage V_{IN}, where the second time interval is after the first time interval.

In particular embodiments, control circuit 22 can soft start switching power supply 20 in the second time interval, and in the soft-start phase, control circuit 22 can control the operating states of bus protection switch Q1, such that output voltage V_{OUT} continues to rise and gradually approaches input voltage V_{IN}. In the soft-start phase, control circuit 22 may adjust output voltage V_{OUT} by adjusting the duty cycle of control signal VQ1 of bus protection switch Q1. Particular embodiments may achieve soft start of the switching power supply by reducing a change rate of the current flowing through inductor L (e.g., the inductor current), that is, prolonging the time the inductor current takes to reach its peak value, or reducing the amplitude of the peak value of the inductor current.

In particular embodiments, the purpose of soft start is that, in the process of turning on bus protection switch Q1, the current flowing through inductor L may not have a large peak, and output voltage V_{OUT} may not exceed input voltage V_{IN}. As an example, the buck converter may have a first duty cycle range in the first time interval, and a second duty cycle range in the second time interval. Each value within the second duty cycle range can be greater than any value within the first duty cycle range.

For example, the buck converter may have a predetermined first duty cycle in the first time interval, and a second duty cycle range in the second time interval. Each value within the second duty cycle range can be greater than the predetermined first duty cycle. In one example, during the second time interval, the buck converter may have a second duty cycle that gradually increases and remains within the second duty cycle range, where with a maximum value of the second duty cycle range is 1. In one example, in the second time interval of the startup phase, the buck converter may have a fixed third duty cycle within the second duty cycle range.

In one example, after the startup phase of switching power supply 20, switching power supply 20 may enter the normal operating phase, during which control signal VQ2 can control main power transistor Q2 in boost converter 21 to be periodically turned on and off, and boost converter 21 can perform voltage conversion on DC input voltage V_{IN} to generate output voltage V_{OUT}.

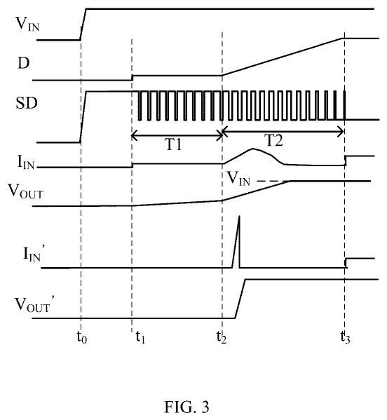

Referring now to FIG. 3, shown is a waveform diagram of example operation of the switching power supply, in accordance with embodiments of the present invention. The example operating process of the full startup phase of switching power supply 20 is described below with reference to FIGS. 2 and 3. In FIGS. 2 and 3, e.g., D is the duty cycle of the buck converter in the startup phase, SD is the PWM signal corresponding to duty cycle D, I_{IN} is the current flowing through bus protection switch Q1, and bus protection switch Q1 is a P-type field-effect transistor.

At moment to, switching power supply 20 can be powered on, input voltage V_{IN} can begin to rise, at which time, both bus protection switch Q1 and main power transistor Q2 may be in an off state, duty cycle D can be 0, PWM signal SD may be close to input voltage V_{IN}, and input current I_{IN} may be 0.

The interval from t₁ to t₂ is the first time interval (e.g., T1) of the startup phase, serving as the short-circuit detection period. At moment t₁, control circuit 22 may start operating, and the buck converter can begin functioning. In particular embodiments, the buck converter may operate at the predetermined first duty cycle in the first time interval, where the predetermined first duty cycle can be relatively small (e.g., near 5%), such that the current flowing through inductor L is within the preset current range for short-circuit detection. During the short-circuit detection phase, when switching power supply 20 is determined to be in a non-short-circuit condition, output voltage V_{OUT} may rise gradually and switching power supply 20 can enter the second time interval (T2). When switching power supply 20 is determined to be in a short-circuit condition, switching power supply 20 can initially be turned off, and then reenter the startup phase after a predetermined delay.

FIG. 3 also shows waveforms of input current I_{IN}′ and output voltage V_{OUT}′ of the switching power supply without setting a soft start. As shown in FIG. 3, in a solution without soft start, when bus protection switch Q1 is directly turned on at a certain moment after the moment t₂, a large current spike may be formed on inductor L. Also, the current peak may be too large to cause damage to the electronic device, and a large inductor voltage may be formed at two ends of inductor L. At which time, a sum of the inductor voltage and input voltage V_{IN} can be equal to output voltage V_{OUT}′, which may result in an excessively high output voltage V_{OUT}′.

In certain embodiments, the buck converter may also operate in the first duty cycle range. That is, the buck converter may operate at a fixed duty cycle or a varying duty cycle, so long as the current flowing through the inductor is within the preset current range, allowing output voltage V_{OUT} to gradually rise.

From t₂ to t₃, the switching power supply may enter the second time interval (e.g., the soft-start phase) at moment t₂, duty cycle D may gradually increase, and duration of the active level (e.g., the low level) of PWM signal SD can accordingly increase. In this interval, the input current I_{IN} may initially rise and then decrease, and when output voltage V_{OUT} continues to rise and gradually approaches input voltage V_{IN}, the input current I_{IN} can drop to zero and remain stable. At moment t₃, the second time interval of the startup phase concludes, and the switching power supply may transition into the normal operating phase, bus protection switch Q1 can be fully turned on, and boost converter 21 can begin functioning. During the soft-start phase, since duty cycle D of the buck converter gradually increases, the peak value of the charging current to output capacitor C_{OUT} can be reduced, and output voltage V_{OUT} may slowly rise to prolong the power-on time, thereby reducing the power consumption in the soft-start phase.

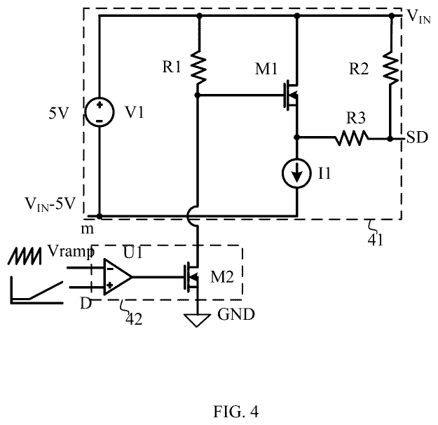

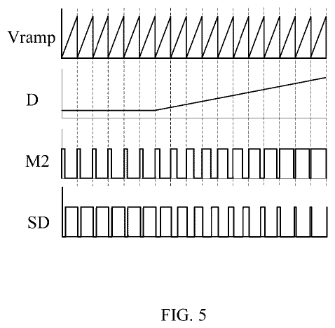

Referring now to FIG. 4 is a schematic block diagram of an example portion of a driving voltage generation circuit of a bus protection switch within the example switching power supply, in accordance with embodiments of the present invention. Referring also to FIG. 5, shown is a waveform diagram of example operation of the driving voltage generation circuit of the bus protection switch within the switching power supply, in accordance with embodiments of the present invention. The circuit shown in FIG. 4 is used for generating PWM signal SD, and the circuit may be divided into driving voltage circuit 41 and driving timing circuit 42.

In particular embodiments, driving voltage circuit 41 can include voltage source V1, transistor M1, current source I1, and resistors R1, R2, and R3. Transistor M1 and current source I1 can connect in series to form a series structure, and the series structure can connect in parallel with voltage source V1. A first power terminal of transistor M1 and a positive electrode of voltage source V1 may both receive input voltage V_{IN}. Also, resistor R1 can connect between the first power terminal of transistor M1 and a control terminal of transistor M1. The resistors R2 and R3 can connect in series between the two power terminals of transistor M1, and PWM signal SD can be generated at a common node between resistors R2 and R3.

Driving timing circuit 42 can include comparator U1 and transistor M2. A non-inverting input terminal of comparator U1 may receive the duty cycle signal representing the change curve of duty cycle D, an inverting input terminal of comparator U1 may receive the ramp signal Vᵣₐₘₚ, and an output terminal of comparator U1 can provide the comparison signal to a control terminal of transistor M2.

A first power terminal of transistor M2 can connect to the control terminal of transistor M1, and a second power terminal of transistor M2 may be grounded. Driving voltage circuit 41 can also include a logic circuit, which can generate control signal VQ1 of bus protection switch Q1 based on short-circuit detection signal V_{S} and PWM signal SD. For example, when the short-circuit detection signal V_{S} is active, control signal VQ1 can enable bus protection switch Q1 to be turned off. Also, when the short-circuit detection signal V_{S} is inactive, control signal VQ1 can be consistent with (e.g., the same as) PWM signal SD of bus protection switch Q1 in the startup phase. During the normal operating phase, PWM signal SD may remain at an active level, short-circuit detection signal V_{S} can be at an inactive level, and control signal VQ1 can control bus protection switch Q1 to be fully turned on.

The operating principle of the circuit used for generating PWM signal SD is described below with reference to FIGS. 4 and 5. When duty cycle D is greater than ramp signal Vᵣₐₘₚ, the comparison signal output by comparator U1 can be a high level, such that transistor M2 is turned on. When transistor M2 is turned on, the control terminal of transistor M1 may be pulled low, and transistor M1 can be turned off. Consequently, current source I1 may flow through resistor R2, so a voltage drop of R2*I1 between input voltage V_{IN} and the output terminal of PWM signal SD can be generated, such that the difference between input voltage V_{IN} and PWM signal SD exceeds a turn-on threshold of bus protection switch Q1, thereby ensuring bus protection switch Q1 is fully turned on. When duty cycle D is lower than ramp signal Vᵣₐₘₚ, the comparison signal output by comparator U1 can be a low level, such that transistor M2 is turned off. When transistor M2 is turned off, the control terminal of transistor M1 can be pulled up to input voltage V_{IN} through resistor R1, and transistor M1 may be turned on. Consequently, the output terminal of PWM signal SD can be shorted to input voltage V_{IN} via transistor M1, resulting in bus protection switch Q1 being turned off.

In particular embodiments, bus protection switch Q1 may operate with a fixed first duty cycle during the first time interval of the startup phase, and with a progressively increasing duty cycle within the second duty cycle range during the second time interval of the startup phase. For example, a progressively increasing duty cycle may be adopted during the first time interval, or a fixed duty cycle may be used in the second time interval. Alternatively, bus protection switch Q1 may be fully turned on throughout the second time interval. In certain embodiments, any suitable circuit structure can be used to generate PWM signal SD, as long as the circuit structure can make PWM signal SD consistent with the variation trend or curve of the predetermined duty cycle D.

Particular embodiments may provide a short-circuit detection method that controls the operating states of the bus protection switch to generate a low current, which can charge the output capacitor during the short-circuit detection phase. A short-circuit fault of the switching power supply can be identified by monitoring whether the output voltage rises to a predetermined value. This approach can eliminate the need for bus detection resistors and differential sampling, thereby reducing the number of required chip pins and simplifying chip design. Additionally, during the soft-start phase, the power-on duration can be extended and the peak of charging current to the output capacitor reduced, thus allowing the output voltage to rise gradually, thereby slowing the ramp rate of the output voltage, and enabling the output voltage to reach the input voltage, reducing power loss, improving system efficiency, and enhancing operational safety.

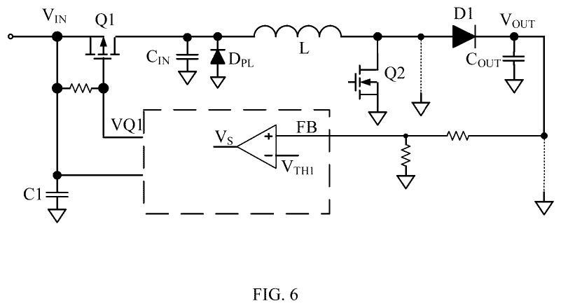

Referring now to FIG. 6, shown is a schematic block diagram of a second example switching power supply, in accordance with embodiments of the present invention. In particular embodiments, two ends of diode D_{PL} can connect in parallel with input capacitor C_{IN}. The short-circuit detection method of particular embodiments can also be compatible to the existence of input capacitor C_{IN} to a certain extent, but the operating principle in this case is, during the short-circuit detection phase, bus protection switch Q1, diode D_{PL} and inductor L may not form a buck converter. However, bus protection switch Q1 can still output energy to the output terminal with a small duty cycle, in order to determine whether a short-circuit fault occurs by detecting whether the output voltage can rise to the predetermined value. However, since the input current is not constrained by inductor L, a larger input current may result.

In this particular example, the capacitance value of input capacitor C_{IN} may have less influence on the short-circuit detection. When the capacitance value is small (e.g., at the nF level), the soft-start phase after the short-circuit detection phase may not be affected. However, if the capacitance value is close to, e.g., the uF level, in the soft-start phase, the buck converter including bus protection switch Q1, diode D_{PL}, and inductor L may not operate normally, and may only be replaced in a hard-start mode.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A switching power supply, comprising:
a) a boost converter configured to perform voltage conversion on an input voltage of an input terminal of the switching power supply to generate an output voltage of an output terminal of the switching power supply in a normal operating phase;
b) a bus protection switch coupled between the input terminal of the switching power supply and the boost converter, and configured to be turned off in response to a short-circuit fault of the switching power supply;
c) a first diode coupled between a common node between the bus protection switch and the boost converter and a ground terminal; and
d) wherein a duty cycle of the bus protection switch is controlled to make the output voltage rise slowly in at least part of a startup phase, such that a short-circuit detection is performed.

2. The switching power supply of claim 1, wherein the bus protection switch, the first diode, and an inductor in the boost converter form a buck converter that is configured to receive the input voltage, and to convert the input voltage into the output voltage in the startup phase.

3. The switching power supply of claim 2, further comprising:
a) a control circuit configured to control the buck converter to operate in a first time interval of the startup phase to make the output voltage rise gradually; and
b) wherein in the first time interval, the control circuit determines whether the switching power supply has a short-circuit fault by comparing a feedback signal of the output voltage against a first threshold.

4. The switching power supply of claim 3, wherein:
a) when the feedback signal of the output voltage is detected to be lower than the first threshold, the control circuit determines that the switching power supply has a short-circuit fault; and
b) when the feedback signal of the output voltage can rise to the first threshold, the control circuit determines that no short-circuit fault is present in the switching power supply.

5. The switching power supply of claim 3, wherein:
a) when the feedback signal of the output voltage rises to the first threshold during the first time interval, the control circuit is configured to initiate a soft start of the switching power supply in a second time interval of the startup phase; and
b) the second time interval is after the first time interval.

6. The switching power supply of claim 3, wherein when the feedback signal of the output voltage is detected to be lower than the first threshold during the first time interval of the startup phase or in the normal operating phase, the control circuit is configured to turn off the bus protection switch or be controlled to stop operating, and then to reenter the startup phase after a predetermined delay.

7. The switching power supply of claim 5, wherein in the second time interval, the control circuit controls the output voltage generated by the buck converter to soft start the switching power supply, in order to make the output voltage rise and approach the input voltage.

8. The switching power supply of claim 5, wherein:
a) the buck converter has a first duty cycle range in the first time interval and a second duty cycle range in the second time interval; and
b) value within the second duty cycle range is greater than any value within the first duty cycle range.

9. The switching power supply of claim 8, wherein a second duty cycle of the buck converter increases and remains within the second duty cycle range during the second time interval, and a maximum value of the second duty cycle range is 1.

10. The switching power supply of claim 5, wherein:
a) the buck converter has a predetermined first duty cycle in the first time interval and a second duty cycle range in the second time interval; and
b) a value within the second duty cycle range is greater than the predetermined first duty cycle.

11. The switching power supply of claim 10, wherein a second duty cycle of the buck converter increases and remains within the second duty cycle range during the second time interval, and a maximum value of the second duty cycle range is 1.

12. The switching power supply of claim 1, wherein the bus protection switch is a P-type field-effect transistor, a source of the bus protection switch is coupled to the input terminal of the switching power supply, and a drain of the bus protection switch is coupled to the boost converter.

13. The switching power supply of claim 1, wherein a short-circuit protection is implemented in the switching power supply without disposing a sampling circuit between the input terminal of the switching power supply and the boost converter.

14. The switching power supply of claim 5, wherein the soft start of the switching power supply in the second time interval is implemented by controlling the operating states of the bus protection switch to reduce a change rate of a current of the inductor.

15. The switching power supply of claim 8, wherein in the second time interval of the startup phase, the buck converter has a fixed third duty cycle within the second duty cycle range.

16. The switching power supply of claim 2, the buck converter is controlled to operate to make a current of the inductor be within a preset current range in a first time interval of the startup phase, such that the output voltage rises slowly to perform the short-circuit detection.

17. The switching power supply of claim 1, further comprising:
a) an input capacitor coupled to the first diode; and
b) wherein the duty cycle of the bus protection switch is controlled in a first time interval of the startup phase, such that the output voltage rises slowly to perform the short-circuit detection.
